(19) United States
(12) Patent Application Publication
(10) Pub. No.: US 2005/0169207 A1
(43) Pub. Date: Aug. 4, 2005

(54) Method for supporting real time traffic in a mobile radio communications system

(75) Inventor: Vincent Muniere, Meudon (FR)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S., Paris (FR)

(21) Appl. No.: 10/517,370

(22) PCT Filed: Jun. 11, 2003
(86) PCT No.: PCT/FR03/01738

(30) Foreign Application Priority Data
Jun. 11, 2002 (FR) 02/07173

(51) Int. Cl. H04Q 7/00

(52) U.S. Cl. 370/328

(57) ABSTRACT

A method of supporting real-time traffic in a mobile radiocommunications system comprising a radio access network and a core network, in which method the real-time traffic supported in packet mode in the network core is supported in the radio access network by allocating dedicated channels.

The present invention relates in general to mobile radiocommunications systems.

In general, such systems are the subject of standardization, and for further information reference can be made to the corresponding standards, published by the corresponding standards organizations.

In general, in such systems, various types of service can be distinguished, as a function of the required quality of service (QoS). In particular, it is possible to distinguish real-time services corresponding to traffic that is sensitive to transfer delays (as applied in particular to voice, or indeed to “streaming” traffic), and services that are not real-time services, corresponding to traffic that is not sensitive to transfer delays (such as data transfers, in particular).

In general, in such systems, it is also possible to distinguish between different types of service depending on the techniques used for supporting them. Thus, a distinction can be made between circuit mode services and packet mode services. In circuit mode, traffic is transported in dedicated resources or channels that are allocated to a user permanently throughout the duration of a call. In packet mode, traffic is transported in resources or channels that are shared between a plurality of users. Circuit mode thus makes it possible to guarantee transfer delays for each user, but does not provide for efficient utilization of the available resources for all of users. In contrast, packet mode allows all of the available resources to be used efficiently, but does not enable transfer delays to be guaranteed. Circuit mode and packet mode differ not only by the different techniques used for allocating resources, but also by protocol architectures that are different.

Second generation systems of the global system for mobile communications (GSM) type were initially designed to support real-time traffic (essentially voice) in circuit mode. Additional functions were subsequently introduced in such systems, corresponding to the general packet radio service (GPRS) so as to enable them to support non real-time traffic in packet mode.

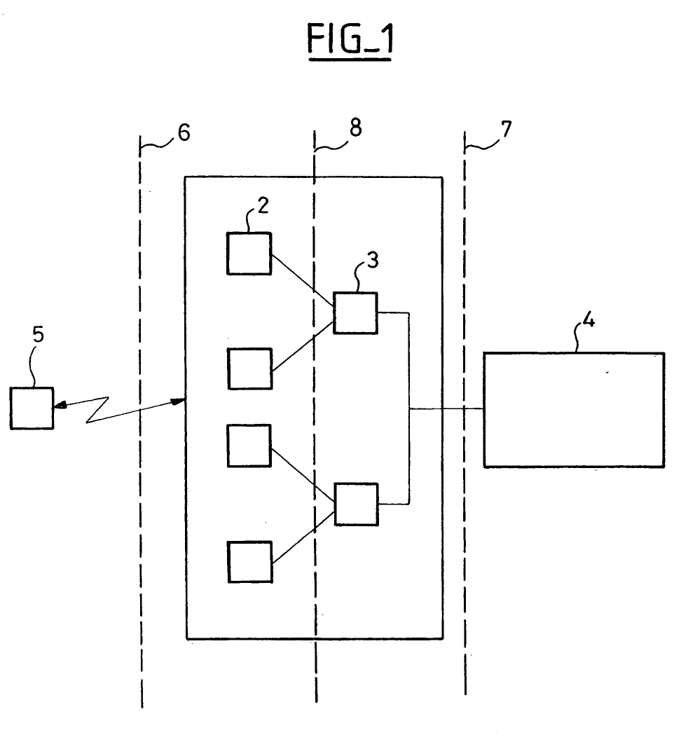

The general architecture of mobile radiocommunications systems is summarized in FIG. 1 and comprises essentially:
a radio access network (RAN) 1; and
a core network (CN) 4.

In that general architecture, the RAN is made up of base stations 2 and base station controllers 3. It is in communication both with mobile terminals via an interface 6 known also as the radio interface, and secondly with the CN 4 via an interface 7. The CN 4 is in communication with external networks (not shown specifically) such as the public switched telephone network (PSTN), the packet data network (PDN), . . . etc.

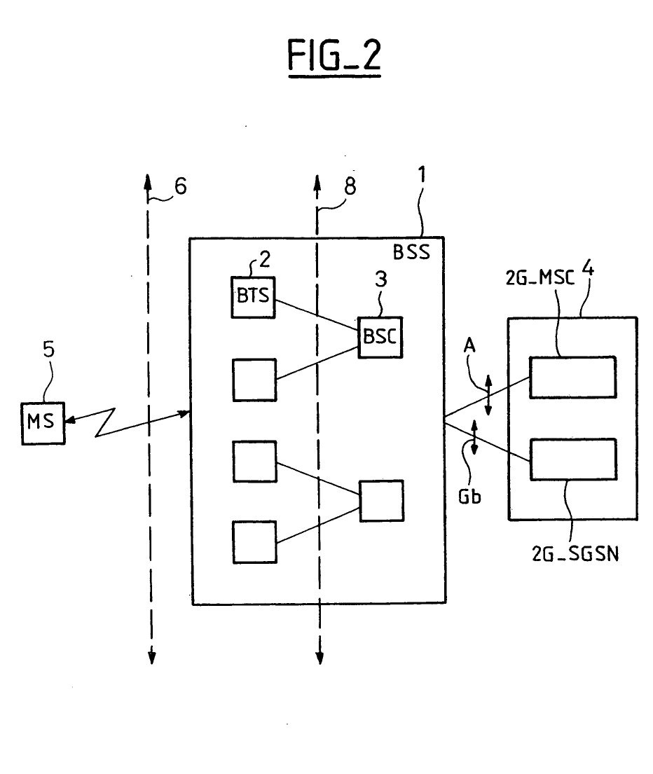

The general architecture of second generation systems of the GSM type is outlined in FIG. 2. In such systems, the RAN is known as the base station subsystem (BSS) and the base stations are referred to as base transceiver stations (BTS), with the base station controllers being abbreviated BSC, and the mobile terminals being referred to as mobile stations (MS). The functions specific to packet mode services are generally supported by a specific unit referred to as a packet control unit (PCU), that is not shown specifically, and that is generally provided in the BSS.

In GMS type second generation systems, the CN comprises:
for circuit mode, second generation mobile switching center (2G-MSC) type entities; and
for packet mode, second generation serving GPRS support node (2G-SGSN) type entities.

Thus, in GSM type second generation systems, the interface 7 includes an interface known as the “A” interface leading to entities of the 2G-MSC type, and an interface known as the “Gb” interface leading to entities of the 2G-SGSN type.

Systems of the GMS enhanced data rates for GSM evolution (EDGE) radio access network (GERAN) type correspond to developments in GSM type systems seeking to provide third generation services, both for real-time applications and for non real-time applications. The object is specifically to be able to support Internet protocol (IP) multimedia subsystem (IMS) type services.

To do this, proposals were initially made to align the services offered by GERAN type systems on those offered by universal mobile radiocommunications system (UMTS) type third generation systems by connecting GERAN type BSSes to the 3G CN via interfaces Iu, said interfaces being used for connecting the UMTS terrestrial radio access network (UTRAN) to the 3G CN.

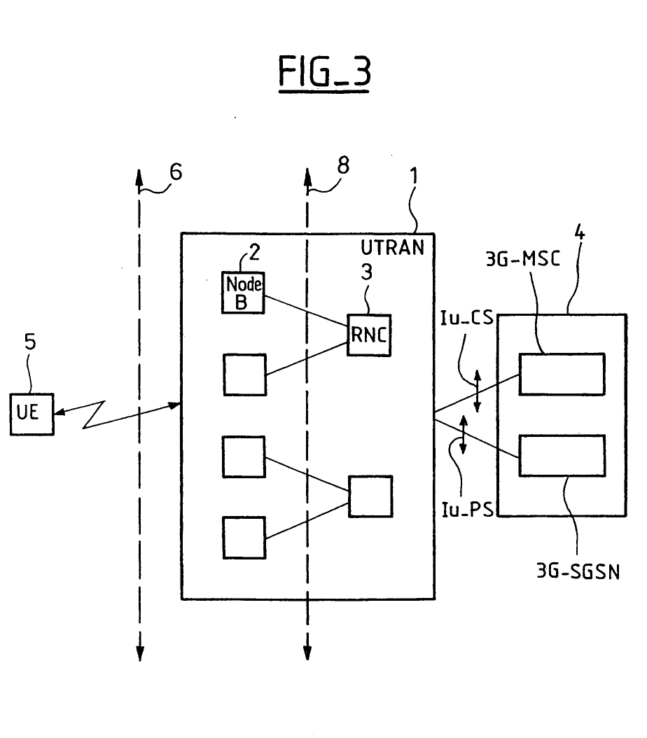

The architecture of UMTS type third generation systems is outlined in FIG. 3. In such systems, the RAN is known as the UTRAN, the base stations are called Node Bs, the base station controllers known as radio network controllers (RNC), and the mobile terminals are known as user equipment (UE).

In UMTS type third generation systems, the CN comprises:
for circuit mode, third generation mobile switching center (3G-MSC) type entities; and
for packet mode, third generation serving GPRS support node (3G-SGSN) type entities.

Thus, in UMTS type third generation systems, the interface 7 includes an interface referred to as the “Iu-CS” interface leading to 3G-MSC type entities, and an interface referred to as the “Iu-PS” interface leading to 3G-SGSN type entities.

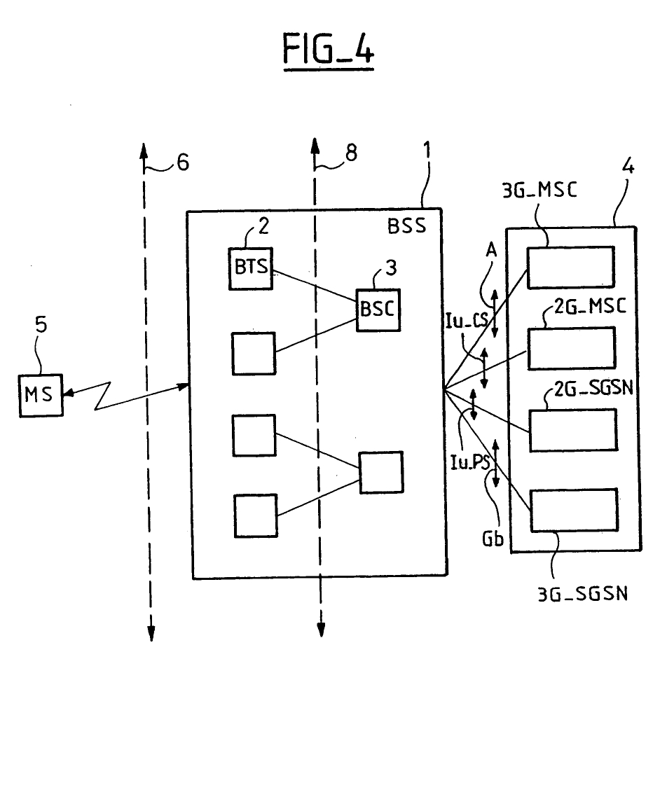

The architecture that was initially proposed for GSM/GERAN type systems is outlined in FIG. 4. It was proposed to introduce into GSM/GERAN type systems, in addition to the already existing “A” and “Gb” interfaces, an interface of the “Iu-CS” type leading to 3G-MSC type entities, and an interface of the “Iu-PS” type leading to 3G-SGSN type entities.

However, it is now understood that such an approach leads to adaptations that are complex and expensive, in particular concerning the radio protocols of layers 2 and 3.

That is why another approach has now been proposed, which consists in supporting the same services as those supported by means of the “Iu-CS” and “Iu-PS” interfaces, but by means of the existing “A” and “Gb” interfaces. The purpose is specifically to be able to support IMS type services via the “Gb” interface. It is recalled that at present the “Gb” interface is capable only of supporting non real-time services (possibly streaming traffic), and that real-time services can be supported only via the “A” interface.

In general, the above approach includes the following improvements for causing so-called “A/Gb” mode to progress towards a mode known as “A/Gb+” mode:
multiple data flows in parallel between BSS and MS;
transfer between cells (known as “handover”) for real-time services in packet mode;
support for real-time services by the radio part (or RAN);
support for real-time services by the network part (or CN);
support for IMS services; and
improvement to security mechanisms.

Until now, the only proposal for supporting real-time services in packet mode over the “Gb” interface has been to provide handover for packet mode services. However handover procedures are specific to circuit mode. In those procedures, resources are reserved in a new cell while a mobile station is still connected to an old cell, thereby making it possible to guarantee transfer delays, at the price of a degree of complexity. In contrast, cell re-selection procedures are specific to packet mode. In those procedures, resources are allocated to a mobile station in a new cell only when the mobile station connects to the new cell, thereby simplifying procedures, but not guaranteeing transfer delays.

The proposal mentioned above makes it possible for packet mode to include mechanisms that are similar to those used in the handover procedures for circuit mode. In addition, procedures have been proposed to enable a mobile station to report radio measurements regularly to the network in order to enable the network to select a new cell, as in circuit mode. To do this, a new combination of channels over the radio interface has been proposed, in particular in document “Tdoc G2-020553, Agenda item 5.3, 3GPP TSG GERAN W2G Sophia-Anitpolis, France, May 27-31, 2002”. That new combination consists in allocating a channel for data transfer in packet mode, referred to as the packet data transfer channel (PDTCH), and also a dedicated signalling channel in circuit mode known as the slow associated control channel (SACCH), which channel is used by the mobile station to make such radio measurement reports to the network.

As observed by the Applicant, such a proposal suffers from the following drawbacks in particular:
the base station BTS and the mobile station MS need to be capable of supporting a new combination of channels;
the PCU entity (which implements the functions specific to packet mode) needs to process measurement reports and implement handover type cell transfer algorithms;
a new procedure needs to be introduced over the radio interface for supporting this new combination; and
problems arise in the architecture of such systems since the SACCH uses a protocol of the link access protocol for the Dm channel (LAPDm) type as its layer 2 protocol, whereas the signalling channel associated with the PDTCH channel, known as the packet associated control channel (PACCH) uses a protocol of the radio link control and medium access control (RLC/MAC) type, with these two protocols terminating in different network nodes (BTS for LAPDm, PCU for RLC/MAC).

Furthermore, the PDTCH channel is a one-way channel whereas real-time services tend to require both-way channels. Even for streaming traffic, which is mainly a one-way application, it seems difficult to allocate the return direction to other users since those users would very likely generate traffic in the other direction, thereby leading to unacceptable preemption of resources for the streaming traffic.

A particular object of the present invention is to propose another approach for supporting real-time services over a “Gb” type interface, making it possible in particular to avoid all or some of the above-mentioned drawbacks, or indeed requiring very little adaptation to existing architectures.

In one aspect, the present invention provides a method of supporting real-time traffic in a mobile radiocommunications system, as defined in the claims.

In another aspect, the present invention provides radio access network equipment for a mobile radiocommunications system, including means for implementing such a method.

In another aspect, the present invention provides network call equipment for a mobile radiocommunications system, including means for implementing such a method.

In another aspect, the present invention provides a mobile station for a mobile radiocommunications system, including means for implementing such a method.

Other objects and characteristics of the present invention appear on reading the following description of an embodiment, given with reference to the accompanying drawings, in which:

FIG. 1 is a diagram summarizing the general architecture of a mobile radiocommunications system;

FIG. 2 is a diagram summarizing the general architecture of a GSM type second generation system;

FIG. 3 is a diagram summarizing the general architecture of a UMTS type third generation system;

FIG. 4 is a diagram summarizing a general architecture as initially proposed for a GERAN type system;

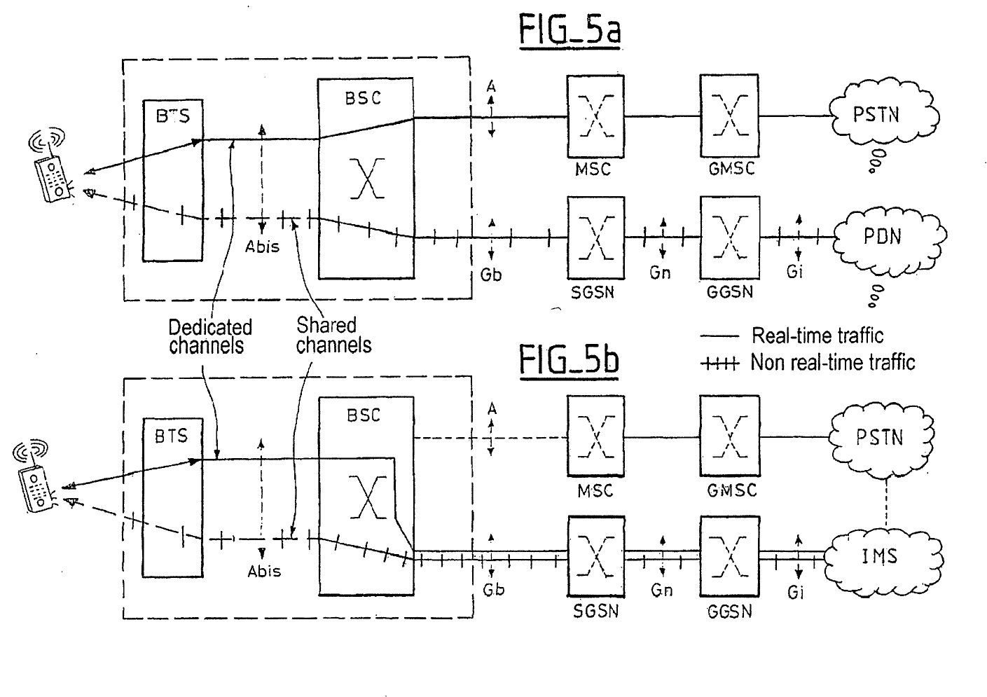

FIGS. 5a and 5b are diagrams for showing by way of comparison the changes proposed by the present invention for the general architecture of a GERAN type system; and

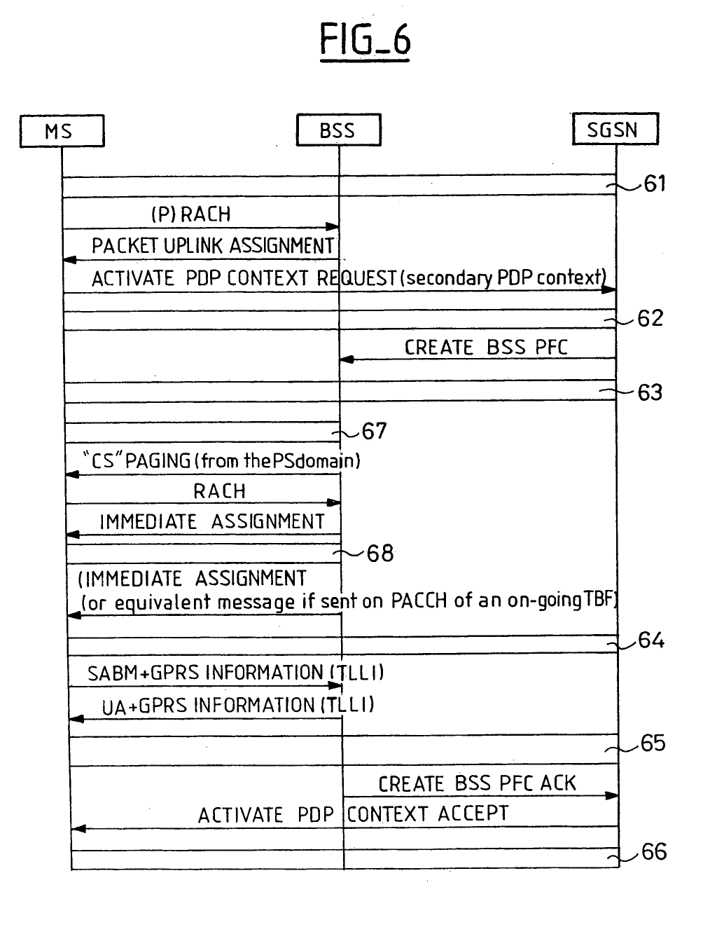

FIG. 6 is a diagram for illustrating an implementation of the method in accordance with the invention.

The present invention suggests using existing radio protocols and channels that are used for real-time services when they are relayed via the MSC. Instead of using shared channels for exchanging packet data units (PDUs) to or from the SGSN, the idea is to use dedicated channels. If real-time services and non real-time services are to be supported simultaneously, existing dual transfer mode (DTM) procedures can be used for controlling the setting up and release of various data flows.

It is briefly recalled that DTM functions are functions enabling two types of service to be supported simultaneously (in circuit mode and in packet mode), for mobile stations capable of supporting both types of service simultaneously, by providing for the BSS to coordinate the resources needed for each of the modes. For a detailed description of these functions, reference can also be made to the corresponding specifications published by the standards organizations.

The changes proposed by the invention can be illustrated by comparing FIGS. 5a and 5b. The equipment shown in FIGS. 5a and 5b is described above with reference to FIG. 2, i.e. BTS, BSC, MSC (or 2G-MSC), and SGSN (or 2G-SGSN); in addition, the connection between an MSC and a PSTN type external network, via a gateway MSC (G-MSC) type entity is shown in FIGS. 5a and 5b; similarly, the connection between an SGSN and a PDN type external network via a gateway GPRS support node (GGSN) type entity is also shown. The interfaces “Abis” between BTS and BSC; “Gn” between SGSN and GGSN, and “Gi” between GGSN and PDN are also shown. Since the object is specifically to be able to support IMS type services, in FIG. 5b, PDN is replaced by IMS.

FIG. 5a corresponds to a conventional architecture, in which the real-time services relayed via a MSC are transported via dedicated channels over the radio interface.

FIG. 5b corresponds to an architecture of the invention, in which the real-time services relayed via an SGSN are transported via dedicated channels over the radio interface.

In the existing GSM architecture, provision is made for two types of unit for processing two types of call, i.e. in circuit mode and in packet mode. These two types of unit might or might not be physically integrated in the same piece of equipment. The unit for processing calls in packet mode, i.e. the packet control unit (PCU) is generally provided in the BSS.

Thus, in general, the BSS includes a unit connected to the “A” interface for processing circuit mode calls, and another unit connected to the “Gb” interface for processing packet mode calls. The circuit mode calls are transported by means of dedicated channels, i.e. channels that are permanently allocated for the duration of the call, whereas the packet mode calls are transported by means of shared channels, i.e. channels shared with other users.

The invention proposes supporting real-time services in the unit connected to the “Gb” interface by means of the following functions:
support for relocating the “Gb” link when the mobile service changes cell and when the new cell is controlled by a BSS that is different from the BSS controlling the old cell, and when a real-time session is in progress via the “Gb” interface;
support for the packet flow context (PFC) procedure for negotiating QoS parameters with the SGSN during activation/modification of the PDP context;
when a PFC is created/modified for a real-time data flow, the unit connected to the “Gb” interface causes a dedicated channel to be established/modified;
real-time data units received from/to the “Gb” interface are transported over the radio interface by means of dedicated channels; and
when a handover is required, the existing procedures and mechanisms defined for the dedicated channels are used; the only difference is that the MSC is not informed; instead, the unit connected to the “Gb” interface is informed, and if necessary relocated the “Gb” link.

Prior to describing an implementation of the present invention, the protocols or procedures specific to packet mode systems or to IMS type architectures are initially recalled since they can be of use in describing the present example.

In the layer architecture used for describing packet mode systems, and in particular systems of the GSM/GPRS type, a distinction is drawn over the radio interface between MS and BSS, between:
a first or “physical” layer; and
a second or “link” layer which is itself subdivided into a plurality of layers, in increasing order the medium access control (MAC) layer, the radio link control (RLC) layer, and the logical link control (LLC) layer.

Similarly, over the “Gb” interface between BSS and SGSN, a distinction is drawn between:
a first or “physical” layer; and
a second or “link” layer itself divided into a plurality of layers: in order of increasing level, a frame relay layer BSSGP (or “BSS GPRS protocol”), and the LLC (i.e. the “logical link control”) layer.

Frames known as LLC frames are formed in the LLC layer on the basis of data units received from a higher or “network” layer via a matching layer using a sub-network dependent convergence protocol (SNDCP). In the LLC frames, these data units are referred to as LLC-protocol data units (LLC-PDUs).

The LLC-PDU data units are subsequently segmented in the RLC/MAC layer so as to form RLC data blocks. The RLC data blocks are then put into the format required for transmission over the radio interface in the physical layer.

In addition, signalling protocols are provided, in particular for radio resource management (RRM) mobility management (MM), session management (SM), and logical link control (LLC), . . . etc.

It is also recalled that in the radio resource management protocol, various modes are possible for a mobile station in packet mode:
a “packet transfer mode” in which resources are allocated temporarily when data is actually to be transmitted during a call, these resources forming a virtual temporary backflow (TBF) channel enabling data to be transferred between the mobile station and the network in a given transmission direction; and
a “packet idle mode”, in which no TBF is established.

In contrast, in circuit mode, the mode in which resources are allocated to a mobile station is known as “dedicated” mode, these resources then being dedicated resources allocated to the mobile station for the duration of the call. When both dedicated resources and shared resources are allocated to a mobile station simultaneously, said mobile station is said to be in “dual transfer” mode.

On being put into operation, a mobile station is also said to be in “idle” mode.

In addition, in the mobility management protocol, a GPRS attach procedure is defined enabling a mobile station to pass from idle mode to a GPRS attach mode in which it can access GPRS services. A converse GPRS detach procedure is also defined.

A mobile station in idle mode that is not GPRS attached communicates with the network by exchanging signals over channels referred to as common control channels (CCCH). A GPRS attached mobile station that is in packet idle mode communicates with the network by exchanging signalling over packet common control channels (PCCCH) if such channels are provided in the cell in question, otherwise over CCCH channels. A GPRS attached mobile station that is in packet transfer mode communicates with the network by exchanging signalling over packet data channels (PDCH).

The packet data channels include a packet data traffic channel (PDTCH) and a packet associated control channel (PACCH).

It is also recalled that the CCCH channel itself includes various channels such as in particular a paging channel (PCH). Similarly, the PCCCH itself includes a certain number of channels, such as, in particular, a packet paging channel (PPCH).

It is also recalled that when a session is to be established in a system such as the GPRS, a packet data protocol (PDP) context activation procedure needs to be launched. The PDP context contains the information needed for transferring data between MS and GGSN (routing information, QoS profile, . . . etc.).

It is also recalled that in an IMS type architecture, signalling relating to multimedia call session control has already been defined for UMTS type technology. Thus, such signalling typically comprises establishing an RRC connection between a mobile station and a RAN, followed by establishing a UMTS bearer for transporting signalling relating to SIP protocol. The radio resource control (RRC) protocol is defined in the 3GPP TS 25.331 standard. The session initiation protocol (SIP) and the session description protocol (SDP) associated therewith are defined by the Internet engineering task force (IETF) which is the standards organization for Internet protocol (IP).

The principal steps in such signalling are as follows, referenced S1, S2, and S3. For simplification purposes, the present description relates to only one of the three segments in which call session control is subdivided, specifically the segment going from the calling UE to its S-CSCF, where the other two segments are the segments going from the called UE to its S-CSCF, and the segment interconnecting the S-CSCF of the calling UE and the S-CSCF of the called UE. It is recalled that the serving-call session control function (S-CSCF) entities and the proxy-call session control function (P-CSCF) are entities of the network core, in charge of controlling multimedia call sessions.

Step S1 corresponds essentially to a preliminary step prior to establishing a session.

Step S1 makes use of a packet mode data protocol context activation procedure known as the packet data protocol context (PDP context), that is needed for transporting signalling for multimedia session control. A PDP context comprises a set of UMTS bearer parameters, such as, in particular: QoS parameters, . . . etc. This step is subsequently followed by another PDP context activation procedure needed for transporting data associated with the multimedia session itself. Since the two DPD contexts relate to the same IP address, step S1 is also referred to as the primary PDP context activation procedure.

Step S1 itself essentially comprises the following steps. In a step S11, a PDP context activation request is transmitted to the UE or the RAN, together with the corresponding end-to-end QoS parameters for the UMTS signalling bearer at SIP level. In a step S12, the 3G-SGSN causes a radio access bearer (RAB) to be established so that a support is available between UE and 3G-SGSN satisfying the QoS constraints. When the RAN receives such a request, after controlling call admission, it sets up a radio bearer (RB) over the radio interface (step S13) and an Iu bearer over the “Iu” interface. Establishment of the RAB can then be confirmed (step S14) and the PDP context can be activated (step S15), after negotiation with the 3G-GGSN (steps S16, S17).

Step S2 corresponds essentially to setting up the multimedia session at SIP protocol level. This step includes negotiation enabling the characteristics for the session that is being set up to be determined. This negotiating includes in particular codec negotiation for determining a list or a set of codecs capable of being supported in common by both parties to the call and authorized by all of the intermediate nodes in the network for the session.

It is recalled that codecs determine simultaneously in the mobile stations and in the radio access network (and in particular in the base stations) and in the network core, how to implement the source coding and the channel coding needed specifically for transmission over the radio interface. For example, for encoding speech, in a GSM type system, there are different types of codec: full rate (FR), enhanced full rate (EFR), half rate (HR), or indeed adaptive multirate (ARM) coding, where adaptive coding is particularly advantageous in that it enables QoS to be optimized (specifically, at each instant and as a function of the transmission conditions encountered, by selecting an optimum combination of given source coding and given channel coding). There exist two types of AMR codecs: the narrow band AMR codec and the wide band AMR code. A wide band AMR type codec provides even better QoS, but it requires higher radio data rates. Speech is merely an example of the various components or media flows that can make up a multimedia session.

The step S2 essentially comprises the following steps. Once an RB has been established for SIP signalling (by preceding step S1), a first task consists for the client SIP discovering its P-CSCF. Thereafter, it needs to declare itself and register itself with its S-CSCF, which will then call other entities of the network core. Finally, while a session is being set up, an SIP invite is sent to the called party via the P-CSCF and S-CSCF entities. This message contains an SDP datagram indicating, for each media flow that the calling UE seeks to set up, a certain number of media parameters such as: media type, combination of QoS attributes, list of codecs capable of being supported for the session, . . . etc. The P-CSCF and S-CSCF entities associated with the calling party and then with the called party then perform a service check on those parameters (in application of criteria specific to the network). The called party then determines amongst other things its own list of codecs capable of being supported for the session, followed by a list of codecs capable of being supported in common by both the calling and called parties, and it returns the common list to the calling party. The calling party then determines which media flows are to be used for the session and which codecs taken from the list are to be used for the session.

Step S3 corresponds essentially to the end of setting up a session, and includes a resource allocation step, on the basis of the media flow characteristics (in terms of QoS attributes, negotiated codec, etc.) as determined in step S2.

Step S3 also uses a PDP context application procedure also known as the secondary PDP context application procedure (in order to distinguish it from the primary context application procedure used in step S1). Step S3 is similar to step S1, except that the parameters of the UMTS bearer to be set up now corresponds to the needs determined during step S2. Step S3 itself comprises steps which are similar to those of step S1, and are therefore not described again.

Step S3 thus comprises setting up an RAB for the secondary PDP context. Once the RAB is set up, the RAN controls admission and either accepts or rejects the call.

It is also recalled, that in general in such systems, it is necessary to provide for QoS management so as to satisfy the needs of the users, while taking account of differences between applications and users, and while also making as efficient use as possible of the transmission resources that are available.

In general, each service is defined by QoS parameters or attributes (such as guaranteed binary data rate, transfer delay, . . . etc.), with the set of these parameters or attributes forming a QoS profile.

For GPRS, QoS management has been improved between versions R97 and R99 of the standard.

In version R97 of the standard, only non real-time services could be offered to users. Thus, in the uplink direction, the mobile station can indicate QoS parameters on requesting the setting up of a TBF in the uplink direction, by using a “two phase” access procedure. In the downlink direction, each LLC PDU receives from the SGSN contains a QoS profile information element giving limited information about quality of service. These parameters can be used by the BSS for distinguishing to some extent between services.

In the R99 version of the standard, a new procedure for creating BSS packet flow context has been introduced and is defined in particular in the 3GPP TS 23.060 and 3GPP TS 08.18 specification. This procedure allows the SGSN and the BSS to negotiate all of the QoS parameters to be offered for transferring the entire LLC-PDU relating to the PFC as created in this way. The SGSN can approve the transverse of LLC-PDUs corresponding to a plurality of given PDP contexts in a single PFC. This is possible if the approved PDP contexts are QoS constraints that are similar. The QoS parameters as negotiated in this way are those as defined in version R99 and they contain much more information than the QoS profile as defined in version R97. In particular, they contain all of the variables needed for defining a real-time service.

The PDP context created while setting up a data session contains the information needed for transferring data between MS and GGSN (routing information, QoS profile, . . . etc.). On activating a PDP context, if the PFC function is implemented in the BSS and the SGSN, then the SGSN can request the QoS parameters from the BSS which can negotiate all or some of these parameters as a function of its loading and of its capacities. This means that the data associated with a PDP context, and thus with a given QoS is well identified, not only in the core network (CN), but also in the radio access network (RAN). This makes it possible to ensure that the QoS offered for the PDP context is negotiated between all of the nodes of the network, thereby making it possible to guarantee certain QoS attributes. It is thus possible to ensure that a guaranteed data rate or a maximum transfer delay can be offered, thereby enabling real-time services to be offered.

In order to support real-time applications, it is necessary for the BSS to be capable of operating the required bit rate and also to be capable of transferring the LLC PDUs it receives within the limits imposed by the maximum transfer delay. To be able to do this, it is necessary for there to be as little queuing as possible in the BSS (where queuing is specific to the way transfer is performed in packet mode systems), and that transfer interruptions (due in particular to selecting another cell, as mentioned above) to be as short as possible. This requires that BSS to be aware at all times of the QoS specifications for transferring such data, or in other words for it to have available a context containing information associated with the QoS profile.

In the BSS packet flow context creation procedure, as specified in particular in document 3GPP TS 23.060, the SGSN can at any time request a BSS PFC to be created, in particular while activating a PDP context.

FIG. 6 is a diagram for showing an implementation of a method in accordance with the invention.

It should be observed that the present invention covers both a call being received by the mobile station (i.e. a mobile terminating call (MT Call)) and a call originating from the mobile station (i.e. a mobile originating call (MO Call)) via the packet domain (or PS domain). One step in the various scenarios is setting up a dedicated channel on creation of a PFC. The 3GPP specifications relating to IMS (23.228 and 24.228) define the various flows for setting up a call, and they are not repeated herein. In all those scenarios, an important step to which the present invention applies in particular is the step of reserving resources. When establishing an MO session, this takes place between sending the final SDP message and the resource reservation successful message. When establishing an MT session, this takes place after the final SDP message has been received from the calling party.

It is assumed that a PDP context for SIP signaling has been established and that the MS is in packet idle mode, when resource reservation is performed (if there is an ongoing TBF, then a first TBF will not be set up).

The following steps can be implemented:

1) The MS triggers activation of the secondary PDP context for the media flow, having the QoS parameters that were negotiated in level SIP. To do this, the MS requests an uplink TBF over the shared channels.

2) When the SGSN receives the “ACTIVATE PDP CONTEXT REQUEST” message from the MS, it creates the PDP context in the SGSN and then sends a CREATE BSS PFC message over the “Gb” interface, so as to request the BSS to reserve the radio resources needed for the real-time media flow.

3) The required QoS specified the real-time characteristics. In this case, it is proposed to authorize the BSS to allocate dedicated resources. Two methods or procedures are proposed when the BSS can allocated such resources in correspondence with the required QoS: using existing techniques as much as possible by sending a paging message to the MS, or else introducing a new allocation message. It may be observed at this stage the MS is necessarily in the GMM READY state since an LLC PDU in the uplink direction has just been sent containing the ACTIVATE PDP CONTEXT REQUEST message.

3a) In a first procedure, the BSS sends a paging message to the MS. In the present state of the standard or A/Gb mode, an MS can receive a circuit mode service paging message only if the CS paging message is received from the MSC. It is proposed herein that the BSS generates a paging message for real-time services after receiving a request from the SGSN. Depending on the radio state of the MS, the paging message may be sent either over the common control channel or over the PACCH of an ongoing TBF. This is similar to a CS paging message, with the exception that an indication needs to be present to specify that this paging message comes from the packet switched (PS) domain. If one or more TBFs are ongoing, the MS will return to the common control channels and initiate a random access procedure by requesting dedicated resources (where another option would be to improve dual transfer mode (DTM) procedures so as to allow the MS to initiate dedicated access via the PACCH of an ongoing TBF). The BSS then allocates dedicated resources and the MS sets up the layer 2 signalling link.

It is also proposed to request the mobile station (MS) to send a GPRS INFORMATION message containing the temporary logical link identifier (TLLI) specific to the MS. This message may also contain an empty LLC frame piggybacked on the SABM. The TLLI is sent to the BSS so that the BSS can associate the newly established connection with the request received in the CREATE BSS PFC message. When the allocated resources do not correspond to the required QoS, a handover may be performed between cells so as to allocate resources that match the request received from the SGSN (or matching the QoS negotiated with the SGSN), providing such resources are available. The GPRS INFORMATION message may be sent over the dedicated control channel (DCCH) once it has been established. It should be observed that any other message containing the TLLI of the MS could be used.

3b) In a second procedure, dedicated resources are allocated directly to the MS: a new message may be introduced avoiding the need to send a paging message to the MS. The BSS would then directly allocate the dedicated resources by means of a new message sent over the common control channels (when the MS is in packet idle mode) or over the PACCH of an ongoing TBF (MS in packet transfer mode). The MS then activates new resources (possibly by switching to RR dual transfer mode if one or more TBFs are already ongoing) and sets up the layer 2 signalling link. As in the first procedure, the MS sends a GPRS INFORMATION message containing the TLLI which is sent to the BSS. Under such circumstances, the resources that are allocated must match the required QoS.

4) The BSS then sends an acknowledgment to the SGSN for creating the PFC. It should be observed that when the BSS cannot allocate resources enabling the required QoS to be established, it can begin by attempting to negotiate QoS parameters, and if the negotiation is successful, it can then set up dedicated channels.

5) PDP context activation is then terminated (by a TBF being set up, or by using the GPRS INFORMATION message, or by using an existing TBF if it is still ongoing).

6) Call set up can then be terminated at SIP level.

Once the session has begun, the real-time PDUs are routed as follows:
in the network to MS direction: GGSN→SGSN (“Gn” interface), SGSN→BSC (“Gb” interface), BSC→BTS (“Abis” interface), BTS→MS (radio interface); and
in the MS to network direction: MS→BTS (radio interface), BTS→BSC (“Abis” interface), BSC→SGSN (“Gb” interface), and SGSN→GGSN (“Gn” interface).

Over the “Gb” and “Gn” interfaces, the PDUs are routed as packets. Over the “Abis” and radio interfaces, the PDUs are transported over dedicated channels.

During the real-time flow, reported radio measurements are sent from the MS to the BSS over the existing SACCH. On the basis of these reported radio measurements, the BSS can perform handovers by using the existing mechanisms.

In FIG. 6:
step 61 indicates that a call is being set up for a real-time media flow, the final SDP has just been sent (for MO) or received (or MT);
step 62 shows that a secondary PDP context is created in the SGSN;
step 63 indicates that the BSS has received a PFC creation request for a real-time stream, and it establishes dedicated resources;
step 64 indicates that the MS activates the allocated dedicated resources;
step 65 indicates that multiframe operation is now established, content has been resolved, and the BSS knows the TLLI of the new connection. A handover is performed if necessary;
step 66 indicates that the SIP call can be set up;
the option corresponding to the first procedure mentioned above is referenced 67; and
the option corresponding to the second procedure specified above is referenced 68.

The various messages referenced in FIG. 6: (P)RACH, PACKET UPLINK ASSIGNMENT, ACTIVATE PDP CONTEXT REQUEST (secondary PDP context), CREATE BSS PFC, CS PAGING (from the PS domain), IMMEDIATE ASSIGNMENT, SABM+GPRS INFORMATION, UA+GPRS INFORMATION, CREATE BSS PFC ACK, ACTIVATE PDP CONTEXT ACCEPT, are all either recalled or defined above. Optionally, for more information about existing messages or procedures, reference can be made to the corresponding specifications for such systems.

It should be observed that the example described above constitutes only one possible way of implementing the invention. It should be understood that it is not possible herein to describe all possible implementations, and that the present application is naturally of general application, and that it is not limited to this particular example.

One of the advantages of the invention is that existing procedures or protocols are reused. In particular, there is no need to introduce a new channel combination, nor a TBF handover. The impacts on a mobile station in application of the R99 version of the standard supporting dual transfer mode (DTM) are reduced to a minimum (the PDP context for which a dedicated channel is allocated must be indicated to the mobile station). There is no need to define a new layer of the protocol above the RLC/MAC layer since the RR layer above LAPDm can be reused. All of the signalling can be performed using existing SACCH and FACCH channels. This does not prevent existing DTM procedures being improved to support simultaneous handovers of real-time traffic transported over dedicated channels and non real-time traffic transported over shared channels. In particular, the invention makes it possible to introduce a support for IMS services in the “A/Gb” mode of the GERAN network at minimum cost.

1. A method of supporting real-time traffic in a mobile radiocommunications system comprising a radio access network and a radio core, in which method the real-time traffic supported in packet mode in the network core is supported in the radio access network by allocating dedicated channels.

2. A method according to claim 1, in which said dedicated channel allocation is performed on creating a packet flow context (PFC).

3. A method according to claim 2, in which said packet flow context is created in the radio access network.

4. A method according to claim 3, in which said packet flow context contains QoS parameters to be offered by the radio access network and negotiated with the network core.

5. A method according to claim 1, in which said real-time traffic corresponds to at least one media flow in a multimedia session.

6. A method according to claim 1, in which said dedicated channel allocation makes use of an allocation procedure comprising a paging message followed by access to the network.

7. A method according got to claim 1, in which said dedicated channel allocation makes use of a direct allocation procedure.

8. A method according to claim 1, in which:
a mobile station to which dedicated channels have been allocated in this way transmits information to the network relating to its own identity; and
on the basis of said information, the network associates a packet flow context with said mobile station, and where appropriate, dedicated channel reallocation is performed in order to satisfy the quality of service required for the mobile station.

9. Radio access network equipment for a radio mobile communication system including means for implementing a method according to claim 1.

10. Radio core equipment for a mobile radiocommunications system including means for implementing a method according to claim 1.

11. A mobile station for a mobile radiocommunications system including means for implementing a method according to claim 1.
